(19) United States
(12) Patent Application Publication
(10) Pub. No.: US 2018/0158140 A1
(43) Pub. Date: Jun. 7, 2018

(54) SMART RAW COTTON TOTAL MANAGEMENT SYSTEM

(71) Applicant: CS KOREA CO, LTD., Daejeon (KR)

(72) Inventor: Myung Hoon CHOI, Daejeon (KR)

(73) Assignee: CS KOREA CO, LTD., Daejeon (KR)

(21) Appl. No.: 15/306,630

(22) PCT Filed: Oct. 21, 2016
(86) PCT No.: PCT/KR2016/011858

§ 371 Date: Oct. 25, 2016

(30) Foreign Application Priority Data
Sep. 28, 2016 (KR) 10-2016-0124502

(51) Int. Cl. G06Q 40/04

(52) U.S. Cl. CPC G06Q 40/04

(57) ABSTRACT

Provided is a smart raw cotton total management system and more particularly, a smart raw cotton total management system which promotes efficiency of raw cotton management by providing a variety of evaluation information on the raw cotton purchased by the member to the member side and totally manages a raw cotton member and a raw cotton supplier by providing purchase prior information to the member when requesting the raw cotton purchase of the member to perform reasonable raw cotton purchase and transaction.

### BACKGROUND OF THE INVENTION

### Field of the Invention

The present invention relates to a smart raw cotton total management system, and more particularly, to a smart raw cotton total management system capable of totally managing a raw cotton member and a raw cotton member by providing purchase prior information as evaluation data of raw cotton supplied from the raw cotton supplier to the raw cotton member so as to perform evaluation and management of the raw cotton purchased by the member and smooth cotton transaction between the raw cotton member and the raw cotton supplier and providing evaluation information on the raw cotton purchased by raw cotton member and a product produced by the raw cotton to the raw cotton member.

### Description of the Related Art

In general, raw cotton means non-processed cotton and the raw cotton cultured and harvested in a farm is primarily pre-processed in a ginnery and then supplied to a raw cotton supplier. The raw cotton supplier supplies the processed raw cotton to a raw cotton member producing a product by using the raw cotton.

The supplier supplying the raw cotton manages information on supply raw cotton and stores and manages quality test information on the raw cotton purchased by the member side purchasing the raw cotton and product quality information on a product produced by the purchased raw cotton.

During raw cotton transaction between the raw cotton member and the supplier, the supplier falsely provides information such as quality, a purchase place, and a raw cotton harvest time on the raw cotton to supply the raw cotton after signing a contract, and thus there is a problem in that the quality of the raw cotton purchased from the member is deteriorated and the quality of the product produced by the raw cotton is deteriorated.

Further, the member receives the raw cotton having excellent quality to evaluate the product by itself when producing the product, and thus a difference in quality from a raw cotton product of other companies, a difference between a purchase price when purchasing the raw cotton and a purchase price of the raw cotton purchased by other companies, and the like may not be determined and it is difficult to express superiority of the product.

To this end, in order to manage evaluation for the raw cotton purchase and the quality, superiority of the product, raw cotton transaction between the member and the supplier, and the like, a management system managing the raw cotton is required between the member and the supplier. Accordingly, the present invention provides a management system which performs raw cotton transaction between the raw cotton member and the supplier and a variety of evaluation on the raw cotton of the member and the supplier.

### SUMMARY OF THE INVENTION

An object of the present invention is to manage, by a raw cotton managing server, a plurality of member systems and a plurality of supplier systems in and generate, by the raw cotton managing server, a variety of evaluation information by using information (information including quality information, price information, purchase time information, raw cotton supplier information, and the like) on the purchase raw cotton provided from the member to the raw cotton managing server and information on a product and provide, by the raw cotton managing server, the generated information to the member.

Further, another object of the present invention is to smoothly purchase raw cotton by the member by providing, by the raw cotton managing server, purchase prior information to the member according to a raw cotton purchase request of the member.

An aspect of the present invention provides a smart raw cotton total management system to manage a member and a raw cotton supplier including:

a raw cotton managing server 100 which stores and manages information on purchased raw cotton for each member and information on a product provided by a plurality of member systems 200 and information on supplied raw cotton for each supplier provided by a plurality of supplier systems 300, generates evaluation information and purchase prior information for a variety of members/suppliers by using the stored information to provide the generated information to the member systems 200, and provides the purchase prior information to the member systems 200 and purchase intention information to the supplier systems 300 when requesting the raw cotton purchase of the member, respectively to perform raw cotton transaction between the member and the supplier;

a plurality of member systems 200 which provides the information on purchased raw cotton and the information on the product to the raw cotton managing server 100, receives a variety of evaluation information on the purchased raw cotton and the product form the raw cotton managing server 100, requests the raw cotton purchase to the raw cotton managing server 100 when purchasing the raw cotton, receives the purchase prior information according to the purchase request from the raw cotton managing server 100, and provides the purchase intention to the raw cotton managing server 100 based on the purchase prior information;

a plurality of supplier systems 300 which receives member information according to a raw cotton specification requested to the raw cotton managing server 100 for supplying the raw cotton to the member side to transact the raw cotton with the member; and

a communication network 400 formed to provide information between the member systems 200 and the raw cotton managing server 100 and provide information between the supplier systems 300 and the raw cotton managing server 100.

According to the present invention, the raw cotton managing server generates a variety of evaluation information by using information (information including quality information, price information, purchase time information, raw cotton purchase place information, and the like) on the purchase raw cotton provided to the raw cotton managing server and information on a product to provide the information to the member, thereby efficiently managing the raw cotton and the quality of the product of the member.

Further, the purchase prior information is provided to the member according to a raw cotton purchase request of the member, thereby selecting a supplier having high reliability and purchasing the raw cotton having excellent quality and a cheap price in the member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram for a smart raw cotton total management system of the present invention;

FIG. 2 is a configuration diagram of a network connection in the smart raw cotton total management system of the present invention;

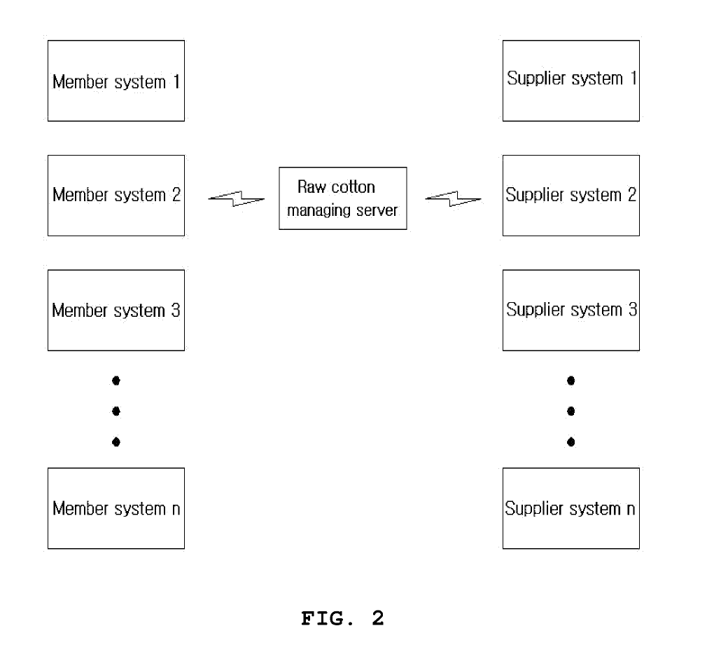

FIG. 3 is a configuration block diagram of a cotton managing server in the smart raw cotton total management system of the present invention; and

FIG. 4 is a configuration block diagram of a member system in the smart raw cotton total management system of the present invention.

### DETAILED DESCRIPTION OF THE EMBODIMENT

Hereinafter, exemplary embodiments of the present invention will be described in detail with reference to the accompanying drawings.

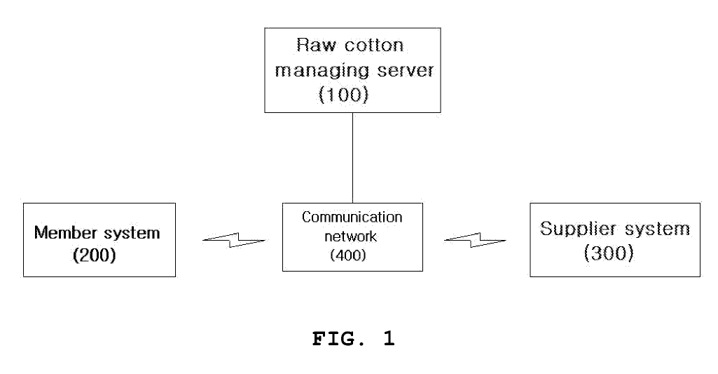

As illustrated in FIG. 1, a smart raw cotton total management system of the present invention to totally manage a member purchasing raw cotton and a supplier supplying the raw cotton includes

a raw cotton managing server 100 which stores and manages information on purchase raw cotton for each member and information on a product provided by a plurality of member systems 200 and information on supply raw cotton for each supplier provided by a plurality of supplier systems 300, generates evaluation information and purchase prior information for a variety of members/suppliers by using the stored information to provide the generated information to the member systems 200, and provides the purchase prior information to the member systems 200 and purchase intention information to the supplier systems 300 when requesting the raw cotton purchase of the member, respectively to perform raw cotton transaction between the member and the supplier;

a plurality of member systems 200 which provides the information on purchase raw cotton and the information on the product to the raw cotton managing server 100, receives a variety of evaluation information on the purchase raw cotton and the product form the raw cotton managing server 100, requests the raw cotton purchase to the raw cotton managing server 100 when purchasing the raw cotton, receives the purchase prior information according to the purchase request from the raw cotton managing server 100, and provides the purchase intention to the raw cotton managing server 100 based on the purchase prior information;

a plurality of supplier systems 300 which provides information on raw cotton to be supplied to the raw cotton managing server 100 for supplying the raw cotton to the member side and receives the purchase intention information from the raw cotton managing server 100 to transact the raw cotton with the member; and

a communication network 400 formed to provide information between the member systems 200 and the raw cotton managing server 100 and provide information between the supplier systems 300 and the raw cotton managing server 100.

The raw cotton managing server 100 receives the information on the raw cotton purchased by the member, the information on the product produced by the member, and the information on the supply raw cotton to be supplied from the supplier to store and manage the received information.

The raw cotton managing server 100 generates the evaluation information for each member/for each supplier and the purchase prior information to provide the generated information to the member systems 200, provides the purchase prior information to the member systems 200 side when requesting the raw cotton purchase to the member, and provides the purchase intention information to the supplier systems 300 side to achieve the raw cotton transaction between the member and the supplier.

The purchase intention information provided to the member side includes evaluation information (as information generated by a supplier evaluation information generating unit to be described below) to supply the raw cotton and information on the supply raw cotton provided by the supplier to supply the raw cotton.

The purchase intention information provided to the supplier side may be a “000 member_A1 raw cotton purchase request” and the like.

The information on the supply raw cotton included in the purchase prior information may include quality information, supply price information, production area information (country, farm, and time information), and the like of the supply raw cotton.

The purchase intention information provided from the raw cotton managing server 100 to the member systems 200 is uploaded and provided on a page for each member formed for each raw cotton managing server 100 or directly transmitted to the corresponding member systems 200.

In the case of providing the purchase intention information to the page for each member formed in the raw cotton managing server 100, the member logs in the raw cotton managing server 100 as a member ID and then accesses his page to receive the purchase intention information.

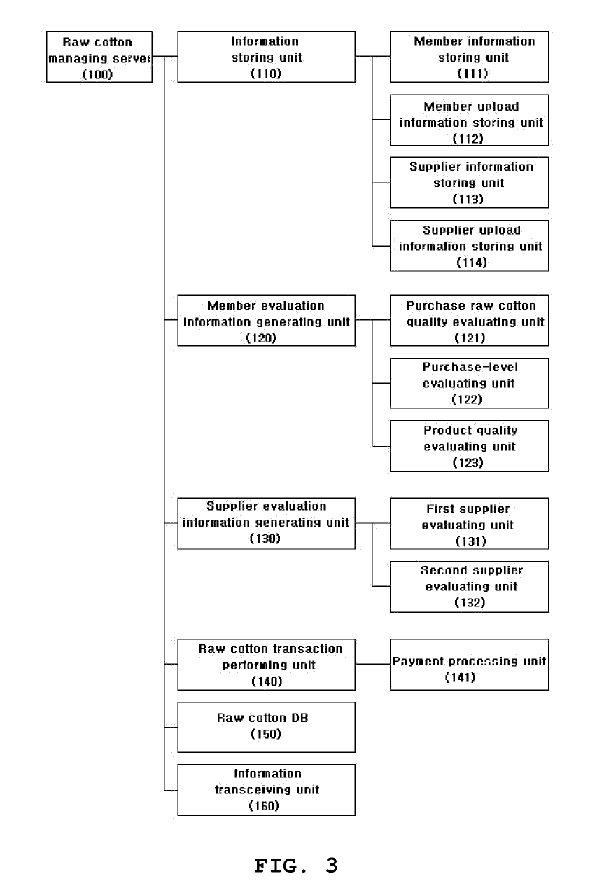

In detail, as illustrated in FIG. 3, the raw cotton managing server 100 includes

an information storing unit 110 which receives and stores information on purchase raw cotton including quality information purchase price information, purchase time information, purchase place information (ginnery, supplier, and yarn area information), and the like on the purchase raw cotton purchased by the member systems from the past to the present and information on a product produced by using the raw cotton from the plurality of member systems 200, receives and stores information on the supply raw cotton including quality information, supply price information, production area information (information for country, farm, and time), and the like of the supply raw cotton from the plurality of supplier systems 300, and stores information generated from the plurality of supplier systems 300, and stores information generated in a member evaluation information generating unit 120, a supplier evaluation information generating unit 130, and a raw cotton transaction executing unit 140;

a member evaluation information generating unit 120 which generates member-specific purchase raw cotton quality evaluation information, purchase-level evaluation information, product quality evaluation information, and the like by using the information on the purchase raw cotton and the information on the product received from the plurality of member systems 200 and the raw cotton information stored in a raw cotton DB 150 to provide the generated information to the member systems 200 through an information transceiving unit 160;

a supplier evaluation information generating unit 130 which generates supplier-specific evaluation information by using the information on the purchase raw cotton including the quality information, the purchase price information, the purchase time information, and the purchase place (including the supplier) information, and the like of the purchase raw cotton received from the plurality of member systems 200, the information on the supply raw cotton including quality information, supply price information, production area information (country-specific, farm-specific, and time-specific information), and the like, and the raw cotton information stored in the raw cotton DB 150 to provide the generated supplier-specific evaluation information to the member systems 200 through the information transceiving unit 160;

a raw cotton transaction performing unit 140 which performs a raw cotton transaction between the member and the supplier by generating supplier-specific purchase prior information by using the supplier-specific evaluation information generated by the supplier evaluation generating unit 130 and the information on the supply raw cotton provided by the supplier system when requesting the raw cotton purchase of the member system 200 to provide the generated supplier-specific purchase prior information to the member system 200 requesting the purchase and providing the purchase intention information to the supplier system 300 of the supplier selected by the member system 200 when the member system 200 selects the specific supplier for purchase;

a raw cotton DB 150 in which quality information, price information, and output information divided for each country, farm, and time of the raw cotton produced in the worldwide are periodically updated and stored; and

an information transceiving unit 160 which is connected to the plurality of member systems 200 and the plurality of supplier systems 300 to transmit the information generated from the raw cotton managing server 100 to the plurality of member systems 200 and the plurality of supplier systems 300 or receive the information provided from the plurality of member systems 200 and the plurality of supplier systems 300.

A variety of information (member-specific purchase raw cotton quality evaluation information, purchase-level evaluation information, product quality evaluation information, supplier-specific evaluation information, and purchase prior information) generated by the member evaluation information generating unit 120, the supplier evaluation information generating unit 130, and the raw cotton transaction performing unit 140 is provided to the member system, and uploaded and provided to the member-specific page formed in each raw cotton managing server 100 or directly transmitted to the corresponding member system 200.

The information storing unit 110 receives and stores the information on the purchase raw cotton purchased from the past and the current and the purchase raw cotton information is information including the quality information, the purchase price information, the purchase time information, and the purchase place information on the raw cotton purchased by the member.

The quality information on the raw cotton is result information when the member tests the purchased raw cotton by itself.

Further, the purchase price information on the raw cotton is purchase price information for each raw cotton grade purchased by a specific supplier, and for example, may be information of “grade A_10,000 won/Kg”.

Further, the raw cotton purchase time information may be time-specific information about a time when the member is purchased by the supplier side, that is, when and where the harvested and processed raw cotton is purchased. For example, the purchase time information may be information about “raw cotton harvested in A farm at 22/03/2016_purchased at 10/05/2016”.

Further, the purchase place information of the raw cotton includes information on a production area culturing the raw cotton, information on ginnery pre-processing the raw cotton, and information on a supplier retaining the pre-processed raw cotton and includes information about which supplier the member purchases the raw cotton, which ginnery the raw cotton purchased by the supplier is processed, and where the production area of the raw cotton is.

For example, the purchase place information may be information about “ginnery A _supplier B _farm C (USA)”.

Further, the purchase place information is the information on the product produced by using the raw cotton received and stored in the member.

The information on the product is information capable of evaluating the quality of the product.

In more detail, the information on the product includes quality information of the raw cotton which is the raw material of the product, production time, a processing type of the raw cotton, quality grade information of the product, and the like.

In the information storing unit 110, the information on the supply raw cotton received and stored from the supplier system 300 includes quality information of the raw cotton to be supplied, supply price information, and production area information of the raw cotton to be supplied.

The quality information of the supply raw cotton is grade-specific quality information on the raw cotton, the supply price information is price information according to a grade, and the production area information is country-specific, farm-specific, and time-specific information about which area the raw cotton is cultured and harvested.

The information on the supply raw cotton stored in the information storing unit 110 may be stored in a form of for example, “grade A raw cotton _20,000 won/Kg_US farm S_harvested at 05/05/2016”.

Further, the information storing unit 110 stores the evaluation information on the raw cotton purchased by the member generated from the member evaluation information generating unit 120 from the past to the current, the supplier evaluation information generated from the supplier evaluation information generating unit 130, the purchase prior information generated from the raw cotton transaction performing unit 140, and the transaction information between the member and the supplier.

Particularly, as illustrated in FIG. 3, the information storing unit 110 includes a member information storing unit 111 for storing information on each member;

a member upload information storing unit 112 for storing, for each member, the information on the purchase raw cotton including the quality information, the purchase price information, the purchase time information, and the purchase place (including the supplier) information, and the like of the purchase raw cotton purchased by the member which is uploaded in the plurality of member systems 200;

a supplier information storing unit 113 for storing information on each supplier; and

a supplier upload information storing unit 114 for storing, for each supplier, the information on the supply raw cotton including quality information, supply price information, production area information (country-specific, farm-specific, and time-specific information), and the like of the supply raw cotton which is uploaded in the plurality of supplier systems 300.

The member information storing unit 111 stores member-specific information which is managed in the raw cotton managing server 100 and stores the information as information on a management code, an address, a membership grade, and the like.

The membership grade is stored as a member having high purchase performance, a member having a best evaluation grade, or the like.

The member upload information storing unit 112 stores information on the purchase raw cotton uploaded by the member, the information on the purchase raw cotton is a management number of the purchase raw cotton, quality information of the raw cotton, purchase price information of the raw cotton, purchase time information of the raw cotton, purchase place (including a supplier) information of the raw cotton, and the like, and the information stored in the member upload information storing unit 112 may be stored as information of for example, a type of “1234567 (raw cotton management number) grade A (raw cotton quality information) 10,000 won /Kg_purchased at 04/06/2016 processed at 01/05/2016 in ginnery A_supplier B”.

The supplier information storing unit 113 stores supplier-specific information which is managed by the raw cotton managing server 100 and stores the information as information on a management code, an address, a supplier grade, and the like for each supplier.

The supplier grade is determined by using the quality, the price information, or the like of the raw cotton supplied by the supplier provided from the corresponding member when there is a raw cotton transaction history with the member and used as supplier evaluation data when the member purchases the raw cotton.

The supplier upload information storing unit 114 stores information on the supply raw cotton uploaded by the supplier and the information on the supply raw cotton uploaded by the supplier is quality information of the supply raw cotton, supply price information of the supply raw cotton, production area information of the supply raw cotton, and the like, and the production area information includes country-specific, farm-specific, and time-specific information.

The information on the supply raw cotton uploaded by the supplier may be stored as information such as “grade A raw cotton_20,000 won/Kg_harvested in US farm S at 05/05/2016”.

The member evaluation information generating unit 120 generates quality evaluation information of the purchase raw cotton, purchase-level evaluation information of the purchase raw cotton, and quality evaluation information of the product produced by the purchased raw cotton by using the information on the purchase raw cotton purchased by the member from the past to the current, the information on the product produced by using the raw cotton, and the raw cotton information stored in the raw cotton DB 150.

Particularly, the member evaluation information generating unit 120 includes a purchase raw cotton quality evaluating unit 121 which generates purchase raw cotton quality evaluation information including absolute quality evaluation information of the purchase raw cotton purchased by the member and relative quality evaluation information for each member of the purchase raw cotton by using the information on the purchase raw cotton received from the member system 200 and the raw cotton information stored in the raw cotton DB 150;

a purchase-level evaluating unit 122 which generates purchase-level evaluation information including quality evaluation information for the purchase price and purchase price evaluation information for the quality by using the information on the purchase raw cotton received from the member system 200 and the raw cotton information stored in the raw cotton DB; and

a product quality evaluating unit 123 which generates product quality evaluation information including absolute quality evaluation information of the product, relative quality evaluation information for each member of the product, and product quality evaluation information for the raw cotton quality by using the information on the purchase raw cotton received from the member system 200, the information on the product, and the raw cotton information stored in the raw cotton DB.

The purchase raw cotton quality evaluating unit 121 is to evaluate the quality of the purchase raw cotton purchased by the member from the past to the current and the purchase raw cotton quality evaluating unit 121 generates the purchase raw cotton quality evaluation information divided into the absolute quality evaluation information and the relative quality evaluation information.

The absolute quality evaluation information is to evaluate the quality based on the raw cotton quality information divided for each country, farm, and time of the raw cotton produced in the worldwide stored in the raw cotton DB of the raw cotton managing server 100 and evaluate the quality of the raw cotton purchased by the member as information of for example, “the quality of raw cotton B of member S is 2-grade quality for the worldwide quality evaluation standard in this year” and the like.

Further, the relative quality evaluation information is to relatively evaluate the raw cotton purchased by each member for each member and uses absolute quality evaluation information generated in the purchase raw cotton quality evaluating unit 121.

That is, the relative quality evaluation information may determine how much the quality of the raw cotton purchased by a specific member is in the quality of the row cotton purchased by each member and may be information such as “the quality of the raw cotton of member S among 100 members is ranked 80” or “the quality of raw cotton B of member S is 20% better than the quality of raw cotton C of member R”.

The purchase-level evaluating unit 122 generates the quality evaluation information for the purchase price and the purchase price evaluation information for the quality by using the information on the purchase raw cotton received from the member system 200 and the raw cotton information stored in the raw cotton DB 150 and generates purchase-level evaluation information capable of determining how good quality of raw cotton is purchased compared to the same price or how cheap the raw cotton is purchased compared to the same quality.

The quality evaluation information for the purchase price may set a population as the members or the raw cotton information stored in the raw cotton DB as the population.

In the case of setting the population as the members, quality evaluation information for the purchase price of the raw cotton of member A is generated by comparing the raw cotton quality of the member A with raw cotton quality of members purchasing the raw cotton with the same purchase price as the raw cotton purchased by the member A and in the case of setting the population as the raw cotton information stored in the raw cotton DB, the quality evaluation information for the raw cotton price formed in the worldwide is generated.

For example, in the case where the population is the members, when the member_A purchases 2-grade raw cotton C with 15,000 won/Kg, the grade is compared with the raw cotton grades of other members purchasing the raw cotton with 15,000 won/Kg. Other members may purchase 1-grade raw cotton with 15,000 won/Kg and also purchase 3-grade raw cotton.

Accordingly, whether the grade of the raw cotton C purchased by the member A with 15,000 won/Kg is appropriate or not is evaluated.

Further, when setting the population as the raw cotton price formed in the worldwide stored in the raw cotton DB, whether the grade of the raw cotton C purchased by the member A with 15,000 won/Kg is a better grade or not than the raw cotton price formed in the worldwide is evaluated.

The purchase price evaluation information for the quality may also set a population as the members or the raw cotton information stored in the raw cotton DB as the population.

For example, in the case where the population is the members, when the member A purchases 2-grade raw cotton by 15,000 won/Kg, the purchase price is compared with the purchase price of other members purchasing the 2-grade raw cotton. Other members may purchase the 2-grade raw cotton with 14,000 won/Kg or 16,000 won/Kg.

Accordingly, whether the 2-grade raw cotton purchased by the member A with 15,000 won/Kg is appropriate or not is evaluated.

Further, when setting the population as the quality formed in the worldwide stored in the raw cotton DB, whether the 2-grade raw cotton purchased by the member A with 15,000 won/Kg is a better price or not than the 2-grade raw cotton price formed in the worldwide is evaluated.

The product quality evaluating unit 123 generates the absolute quality evaluation information and the relative quality evaluation information for the product produced by using the raw cotton purchased by the member and the product quality evaluation information for the raw cotton quality using for producing the product.

The product produced by using the raw cotton may be raw cotton blankets, raw cotton clothes, or the like and kinds or the number of products may be various.

The absolute quality evaluation information for the product is information evaluating the quality of the product based on the quality information of the products produced by using the raw cotton in the worldwide stored in the raw cotton DB of the raw cotton managing server 100 and evaluated as information such as “quality of a raw cotton blanket of member S is 1-grade quality based on the worldwide quality evaluation standard in this year”.

Further, the relative quality evaluation information on the product is to relatively evaluate the product produced by each member for each member and uses absolute quality evaluation information generated in the product quality evaluating unit 123.

The relative quality evaluation information on the product may determine how much quality (absolute quality) of the raw cotton product produced by a specific member is in the quality (absolute quality) of the raw cotton product produced by each member and may be information such as “the quality of a raw cotton product (for example, a blanket) of member S among 100 members is ranked 80” or “the quality of a raw cotton product (for example, a blanket) of member S is 20% better than the quality of a raw cotton product (for example, a blanket) of member R”.

Further, the quality evaluation information of the product for the raw cotton quality using the product is information representing how good the quality of the product is as compared with the raw cotton quality using the product and each member may determine whether its own product producing process is managed well by using the quality evaluation information of the product for the raw cotton quality using the product.

For example, if the quality of a product (for example, a blanket) produced by using 1-grade raw cotton is grade 2, there is a problem in production process management, and if the quality of a product produced by using 2-grade raw cotton is grade 1, it can be seen that the production process management of the member is very well performed.

The supplier evaluation information generating unit 130 generates evaluation information for each supplier by using the information on the purchase raw cotton including the management number, the quality information, the purchase price information, the purchase time information, and the purchase place information of the purchase raw cotton received from the member system 200, the information on the supply raw cotton including the quality information, the supply price information, and the production area information (country-specific, farm-specific, and time-specific information), and the like of the supply raw cotton received from the supplier system 300.

The information on the purchase raw cotton includes the management number of the purchase raw cotton, the quality information of the raw cotton, the purchase price information of the raw cotton, the purchase time information of the raw cotton, the purchase place (including a supplier) information of the raw cotton, and the like and for example, may be a type of “1234567 (raw cotton management number)_grade A (raw cotton quality information) 10,000 won /Kg_purchased at 04/06/2016 processed at 01/05/2016 in ginnery A_supplier B”.

The information on the supply raw cotton may be information of a type of for example, “grade A raw cotton_20,000 won/Kg_harvested in US S farm at 05/05/2016”.

The supplier evaluation information generating unit 130 generates information to be divided into a case of a supplier having a history of supplying the raw cotton to the member and a case of a supplier having no history when generating the evaluation information on the supplier.

The supplier evaluation information generating unit 130 includes a first supplier evaluating unit 131 which extracts quality information, purchase price information, and contract information of the raw cotton supplied by the supplier to be evaluated from the information on the purchase raw cotton provided by the member and generates evaluation information for each supplier by using the extracted information, the information on the supply raw cotton to be supplied by the supplier to be evaluated, and the information stored in the raw cotton DB 150, in the case of the supplier having a history that the supplier to be evaluated supplies the raw cotton to at least one member; and

a second supplier evaluating unit 132 which generates evaluation information for each supplier by using the information on the supply raw cotton to be supplied by the supplier to be evaluated and the information stored in the raw cotton DB 150, in the case of a supplier having no history that the supplier to be evaluated supplies the raw cotton to at least one member.

The first supplier evaluating unit 131 generates contract information when signing the contract with the member, quality information and purchase price information of the supply raw cotton supplied by the actual member, information stored in the raw cotton DB 150, and information on the supply raw cotton to be supplied by the supplier to be evaluated, in the case of the supplier having a history of supplying the raw cotton to at least one member.

By comparing the contract information when signing the contract with the member with the quality information and the purchase price information of the supply raw cotton supplied by the actual member in the information, whether the supplier supplies the appropriate raw cotton to the member according to the contract details is determined. By comparing the information stored in the raw cotton DB 150 with the information on the supply raw cotton to be supplied by the supplier to be evaluated, whether the supplier supplies the raw cotton with a price and quality which are currently formed in the worldwide is determined.

Since the quality information, the price information, and the output information divided for each country, each farm, and each time of the raw cotton produced in the worldwide is stored in the raw cotton DB 150, whether the raw cotton to be supplied by the supplier is appropriate may be determined.

That is, the first supplier evaluating unit 131 generates evaluation information for each supplier which may determine ethicality, market price appropriateness, or the like of the specific supplier to supply the raw cotton.

The second supplier evaluating unit 132 generates evaluation information for each supplier by using the information stored in the raw cotton DB 150 and the information on the supply raw cotton to be supplied by the supplier to be evaluated, in the case of the supplier having no history that the supplier supplies the raw cotton to one member.

That is, by comparing the information stored in the raw cotton DB 150 with the information on the supply raw cotton to be supplied by the supplier to be evaluated, whether the supplier supplies the raw cotton with the price and the quality which are currently formed in the worldwide is determined.

Since the quality information, the price information, and the output information divided for each country, each farm, and each time of the raw cotton produced in the worldwide is stored in the raw cotton DB 150, whether the raw cotton to be supplied by the supplier is appropriate may be determined.

That is, the second supplier evaluating unit 132 generates evaluation information for each supplier which may determine market price appropriateness, or the like of the specific supplier to supply the raw cotton.

For example, when the information on the supply raw cotton to be supplied by the supplier to be evaluated is information such as “raw cotton C_harvested in US farm A at 02/03/2016_1-grade raw cotton state_complete pretreatment process at 04/03/2016 complete pretreatment process” and the information on the raw cotton C stored in the raw cotton DB 150 is “harvested at 02/03/2016 in US farm A_raw cotton state 1 grade”, it is determined that information for each country, each farm, and each harvesting time of the raw cotton C is matched and thus a reliability grade of the supplier is excellent. If the information on the raw cotton C stored in the raw cotton DB 150 is “harvested at 02/05/2016 in US farm B_raw cotton state 2 grade”, it is determined that information for each country, each farm, and each harvesting time of the raw cotton C is not matched and thus the reliability grade of the supplier is bad, and as a result, the evaluation information is generated.

The raw cotton transaction performing unit 140 generates purchase prior information which is prior information for purchasing when requesting the raw cotton purchase to the raw cotton managing server 110 from the member system 200.

The purchase prior information includes information on supply raw cotton proposed by the supplier to supply the raw cotton and supplier evaluation information on the supplier to supply the raw cotton generated by the supplier evaluation information generating unit 130.

That is, the raw cotton transaction performing unit 140 generates information on the supply raw cotton provided by the raw cotton supplier which is information required by the member requesting the raw cotton purchase and supplier evaluation information capable of determining ethicality or market price appropriateness of the corresponding supplier.

When the member system 200 selects a specific supplier after verifying the purchase prior information to transmit information on the selected supplier, the raw cotton managing server 100 provides purchase intention information on the raw cotton purchase to the supplier system 300 side of the supplier selected from the member side, and then the raw cotton transaction between the member and the supplier is performed.

The raw cotton transaction performing unit 140 may further include a payment processing unit 141 which performs payment for transaction fees from the supplier or the member when the raw cotton transaction between the member and the supplier is performed.

The payment processing unit 141 performs the payment by depositing full transaction fee from the supplier or full transaction fee from the member or selecting transaction fee at a predetermined ratio according to contract details contracted during raw cotton transaction between the supplier and the member, when the raw cotton transaction between the member and the supplier is performed through the raw cotton managing server 100.

The raw cotton DB 150 stores raw cotton information including quality information on the raw cotton divided for each country, each farm, and each time (harvest), price information on the raw cotton, and output information and the raw cotton information is periodically updated and stored.

The raw cotton information stored in the raw cotton DB 150 may be stored as information such as “US_farm S_harvested at 01/01/2016_**$/ton_pretreated at 01/02/2016_1-grade 5000 ton” and “Philippine_farm A_harvested at 02/04/2016_**$/ton pretreated at 02/07/2016_2-grade_2000 ton”.

The information transceiving unit 160 receives purchase raw cotton information and the like from the member system 200 through the communication network 400 or transmits a variety of information generated from the raw cotton managing server 100 to the member system 300 side.

Further, the information transceiving unit 160 receives the supply raw cotton information and the like from the supplier system 300 side or transmits the information generated from the raw cotton managing server 100 to the supplier system 300 side.

The member system 200 provides the information on the purchased raw cotton and the information on the product produced by using the raw cotton to the raw cotton managing server 100 side.

The information on the purchase raw cotton includes quality information purchase price information, purchase time information, purchase place information (ginnery, supplier, and yarn area information), and the like on the purchase raw cotton purchased from the past to the present.

Further, the member system 200 receives a variety of evaluation information (member-specific purchase raw cotton quality evaluation information, purchase-level evaluation information, product quality evaluation information, and supplier-specific evaluation information) from the raw cotton managing server 100, request the raw cotton purchase to the raw cotton managing server 100 for the raw cotton purchase, receives the purchase prior information for the purchase request, and provides the raw cotton purchase intention to the raw cotton managing server 100 side base on the purchase prior information.

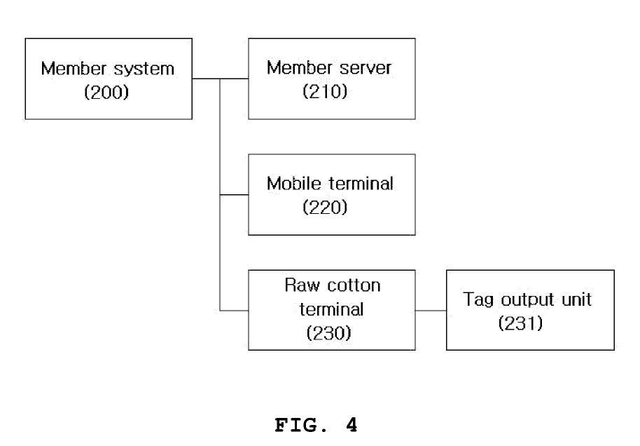

Particularly, as illustrated in FIG. 4, the member system 200 includes a member server 210 which stores raw cotton management information including information on the purchase raw cotton provided by a user's input or provided by a raw cotton terminal 230, the information on the product, and warehousing and release information of the raw cotton or the product, provides the information on the purchase raw cotton and the information on the product to the raw cotton managing server 100, stores variety of evaluation information and purchase prior information provided from the raw cotton managing server 100, and provides purchase request information to the raw cotton managing server 100 when purchasing the raw cotton;

a mobile terminal 220 which receives variety of evaluation information, purchase prior information, and the like from the raw cotton managing server 100 through a radio communication with the raw cotton managing server 100, requests and receives desired search information of the user to the raw cotton managing server 100, and inquires and receives the raw cotton management information by accessing the member server 210; and

a raw cotton terminal 230 which reads information on the purchase raw cotton and information on the product from a tag attached to the purchase raw cotton or the product, provides the read information on the purchase raw cotton and information on the product to the member server 210, performs management including the warehousing and release information of the raw cotton or the product, and provides the managed result to the member server 210.

The member server 210 stores raw cotton management information (information including the information on the purchase raw cotton, the information on the product, and the warehousing and release information of the raw cotton or the product) and the raw cotton management information may be directly input by the user or input by the raw cotton terminal 230.

The information on the purchase raw cotton in the raw cotton management information includes quality information, purchase price information, purchase time information, purchase place information, and the like of the purchase raw cotton.

Further, the information on the product in the raw cotton management information is quality information on the product, that is, information of “raw cotton C processed at 01/02/2016 test result 1 grade”, the warehousing and release information of the raw cotton or the product is stored as information such as “warehousing at 11/07/2016 of raw cotton C purchased by supplier A” or “release at 30/07/2016 of 1-grade raw cotton C processed at 13/03/2016”.

The mobile terminal 220 receives variety of evaluation information, purchase prior information, and the like through a radio communication with the raw cotton managing server 100. The received type may verify information by directly receiving the information or accessing a corresponding page for each member constructed in the raw cotton managing server.

Further, the mobile terminal 220 may request the user's desired search information to the raw cotton managing server 100 side and receive the requested information.

Further, the mobile terminal 220 inquires the raw cotton management information stored in the member server 210 by accessing the member server 210 to allow the user to easily verify and manage the raw cotton management information in other areas or other places.

The mobile terminal 220 may be a smart phone, but the present invention is not limited thereto.

The raw cotton terminal 230 verifies information on purchase raw cotton and a product from a tag attached to the raw cotton purchased and retained by the member or the product produced by the raw cotton and provides the verified information on the purchase raw cotton and the product to the member server 210.

That is, the raw cotton terminal 230 may verify quality information, purchase price information, purchase time information, purchase place information, and the like as the information on the purchase raw cotton information from the tag attached to the raw cotton and verify information on product quality such as a production date and a production grade from the tag attached to the product.

The raw cotton terminal 230 may provide the information on the raw cotton or the product input by the user in the field to the member sever 210 when the tag is not attached to the raw cotton or the product. Further, the raw cotton terminal 230 may include a tag output unit 231 which outputs the tag including the input information on the raw cotton or the product to attach the tag to the raw cotton or the product.

The tag output unit 231 is formed in the raw cotton terminal and outputs the tag when the user inputs the information on the raw cotton or the product in the field, in the case where the tag is not attached to the raw cotton or the product.

The output tag is attached to the raw cotton or the product and used for managing the raw cotton or the product.

The supplier system 300 provides information on the supply raw cotton including quality information, supply price information, production area information (information for country, farm, and time), and the like of the supply raw cotton to be supplied to the raw cotton managing server 100 side and receives the purchase intention information from the raw cotton managing server 100 to perform raw cotton transaction with the member showing the purchase intention.

The communication network 400 is a radio communication network formed to provide information between the member system 200 and the raw cotton managing server 100 and provide information between the supplier system 300 and the raw cotton managing server 100.

The technical spirit of the present invention has been described together with the accompanying drawings hereinabove, but this exemplarily describes a preferred embodiment of the present invention and does not limit the present invention. Further, it is apparent to all those skilled in the art that various modifications and imitations can be made within the range without departing from the scope of the technical spirit of the present invention.

What is claimed is:

1. A smart raw cotton total management system to totally manage a member purchasing raw cotton and a supplier supplying the raw cotton, the system comprising:
a raw cotton managing server (100) which stores and manages information on purchased raw cotton for each member and information on a product provided by a plurality of member systems (200) and information on supplied raw cotton for each supplier provided by a plurality of supplier systems (300), generates evaluation information and purchase prior information for a variety of members/suppliers by using the stored information to provide the generated information to the member systems (200), and provides the purchase prior information to the member systems (200) and purchase intention information to the supplier systems (300) when requesting the raw cotton purchase of the member, respectively to perform raw cotton transaction between the member and the supplier;
a plurality of member systems (200) which provides the information on purchased raw cotton and the information on the product to the raw cotton managing server (100), receives a variety of evaluation information on the purchased raw cotton and the product form the raw cotton managing server (100), requests the raw cotton purchase to the raw cotton managing server (100) when purchasing the raw cotton, receives the purchase prior information according to the purchase request from the raw cotton managing server (100), and provides the purchase intention to the raw cotton managing server (100) based on the purchase prior information;
a plurality of supplier systems (300) which provides information on raw cotton to be supplied to the raw cotton managing server (100) for supplying the raw cotton to the member side and receives the purchase intention information from the raw cotton managing server (100) to transact the raw cotton with the member; and
a communication network (400) formed to provide information between the member systems (200) and the raw cotton managing server (100) and provide information between the supplier systems (300) and the raw cotton managing server (100).

2. The smart raw cotton total management system of claim 1, wherein the raw cotton managing server (100) includes:
an information storing unit 110 which receives and stores information on purchase raw cotton including quality information purchase price information, purchase time information, purchase place information (ginnery, supplier, and yarn area information), and the like on the purchase raw cotton purchased by the member systems from the past to the present and information on a product produced by using the raw cotton from the plurality of member systems (200), receives and stores information on the supply raw cotton including quality information, supply price information, production area information (information for country, farm, and time), and the like of the supply raw cotton from the plurality of supplier systems (300), and stores information generated from the plurality of supplier systems (300), and stores information generated in a member evaluation information generating unit (120), a supplier evaluation information generating unit (130), and a raw cotton transaction executing unit (140);
a member evaluation information generating unit (120) which generates purchase raw cotton quality evaluation information for each member, purchase-level evaluation information, product quality evaluation information, and the like by using the information on the purchase raw cotton and the information on the product received from the plurality of member systems (200) and the raw cotton information stored in a raw cotton DB (150) to provide the generated information to the member systems (200) by an information transceiving unit (160);
a supplier evaluation information generating unit (130) which generates supplier-specific evaluation information by using the information on the purchase raw cotton including the quality information, the purchase price information, the purchase time information, and the purchase place (including the supplier) information, and the like of the purchase raw cotton received from the plurality of member systems (200), the information on the supply raw cotton including quality information, supply price information, production area information (country-specific, farm-specific, and time-specific information), and the like, and the raw cotton information stored in the raw cotton DB (150) to provide the generated supplier-specific evaluation information to the member systems (200) through the information transceiving unit (160);
a raw cotton transaction performing unit (140) which performs a raw cotton transaction between the member and the supplier by generating supplier-specific purchase prior information by using the supplier-specific evaluation information generated by the supplier evaluation generating unit (130) and the information on the supply raw cotton provided by the supplier system when requesting the raw cotton purchase of the member system (200) to provide the generated supplier-specific purchase prior information to the member system (200) requesting the purchase and providing the purchase intention information to the supplier system (300) of the supplier selected by the member system (200) when the member system (200) selects the specific supplier for purchase;
a raw cotton DB (150) in which quality information, price information, and output information divided for each country, farm, and time of the raw cotton produced in the worldwide are periodically updated and stored; and
an information transceiving unit (160) which is connected to the plurality of member systems (200) and the plurality of supplier systems (300) to transmit the information generated from the raw cotton managing server (100) to the plurality of member systems (200) and the plurality of supplier systems (300) or receive the information provided from the plurality of member systems (200) and the plurality of supplier systems (300).

3. The smart raw cotton total management system of claim 2, wherein the information storing unit (110) includes:
a supplier information storing unit (111) for storing information on each supplier; and
a member upload information storing unit (112) for storing, for each member, the information on the purchase raw cotton including the quality information, the purchase price information, the purchase time information, and the purchase place (including the supplier) information, and the like of the purchase raw cotton purchased by the member which is uploaded in the plurality of member systems (200);
a supplier information storing unit (113) for storing information on each supplier; and
a supplier upload information storing unit (114) for storing, for each supplier, the information on the supply raw cotton including quality information, supply price information, production area information (country-specific, farm-specific, and time-specific information), and the like of the supply raw cotton which is uploaded in the plurality of supplier systems (300).

4. The smart raw cotton total management system of claim 2, wherein the member evaluation information generating unit (120) includes:
a purchase raw cotton quality evaluating unit (121) which generates purchase raw cotton quality evaluation information including absolute quality evaluation information of the purchase raw cotton purchased by the member and relative quality evaluation information for each member of the purchase raw cotton by using the information on the purchase raw cotton received from the member system (200) and the raw cotton information stored in the raw cotton DB (150);
a purchase-level evaluation unit (122) which generates purchase-level evaluation information including quality evaluation information for the purchase price and purchase price evaluation information for the quality by using the information on the purchase raw cotton received from the member system (200) and the raw cotton information stored in the raw cotton DB; and
a product quality evaluation unit (123) which generates product quality evaluation information including absolute quality evaluation information of the product, relative quality evaluation information for each member of the product, and product quality evaluation information for the raw cotton quality by using the information on the purchase raw cotton received from the member system (200), the information on the product, and the raw cotton information stored in the raw cotton DB.

5. The smart raw cotton total management system of claim 2, wherein the supplier evaluation information generating unit (130) includes:
a first supplier evaluating unit (131) which extracts quality information, purchase price information, and contract information of the raw cotton supplied by the supplier to be evaluated from the information on the purchase raw cotton provided by the member and generates evaluation information for each supplier by using the extracted information, the information on the supply raw cotton to be supplied by the supplier to be evaluated, and the information stored in the raw cotton DB (150), in the case of the supplier having a history that the supplier to be evaluated supplies the raw cotton to at least one member; and
a second supplier evaluating unit (132) which generates evaluation information for each supplier by using the information on the supply raw cotton to be supplied by the supplier to be evaluated and the information stored in the raw cotton DB (150), in the case of a supplier having no history that the supplier to be evaluated supplies the raw cotton to at least one member.

6. The smart raw cotton total management system of claim 2, wherein the raw cotton transaction performing unit (140) further includes a payment processing unit (141) which performs payment for transaction fees from the supplier or the member when the raw cotton transaction between the member and the supplier is performed.

7. The smart raw cotton total management system of claim 1, wherein the member system (200) includes:
a member server (210) which stores raw cotton management information including information on the purchase raw cotton provided by a user's input or provided by a raw cotton terminal (230), the information on the product, and warehousing and release information of the raw cotton or the product, provides the information on the purchase raw cotton and the information on the product to the raw cotton managing server (100), stores variety of evaluation information and purchase prior information provided from the raw cotton managing server (100), and provides purchase request information to the raw cotton managing server (100) when purchasing the raw cotton;
a mobile terminal (220) which receives variety of evaluation information, purchase prior information, and the like from the raw cotton managing server (100) through a radio communication with the raw cotton managing server (100), requests and receives desired search information of the user to the raw cotton managing server (100), and inquires and receives the raw cotton management information by accessing the member server (210); and
a raw cotton terminal (230) which reads information on the purchase raw cotton and information on the product from a tag attached to the purchase raw cotton or the product, provides the read information on the purchase raw cotton and information on the product to the member server (210), performs management including the warehousing and release information of the raw cotton or the product, and provides the managed result to the member server (210).

8. The smart raw cotton total management system of claim 7, wherein the raw cotton terminal (230) provides the information on the raw cotton or the product input by the user in the field to the member sever (210) when the tag is not attached to the raw cotton or the product and further includes a tag output unit (231) which outputs the tag including the input information on the raw cotton or the product to attach the tag to the raw cotton or the product.

9. The smart raw cotton total management system of claim 1, wherein the raw cotton managing server (100) generates the evaluation information for each member/for each supplier and the purchase prior information to provide the generated information to the member systems (200) and the information is uploaded and provided on a page for each member formed for each raw cotton managing server (100) or directly transmitted to the corresponding member systems (200).
